(19) United States
(12) Patent Application Publication
(10) Pub. No.: US 2026/0246832 A1
(43) Pub. Date: Aug. 20, 2026

(54) AUTONOMOUS DECENTRALIZED SERVER SYNCHRONIZATION

(71) Applicant: Visa International Service Association, San Francisco, CA (US)

(72) Inventors: Prakhar GANGWAR, Karnataka (IN); Ravi Shanker Kumar SINHA, Karnataka (IN); Prithwish BANERJEE, Bangalore (IN); Abinesh DEVADAS, Bengaluru (IN); Pradeep CHOUBE, Uttar Pradesh (IN); Shankar RC, Bengaluru (IN); Shivam MOHAN, U.P (IN)

(73) Assignee: Visa International Service Association, San Francisco, CA (US)

(21) Appl. No.: 19/161,834

(22) PCT Filed: Mar. 14, 2023
(86) PCT No.: PCT/US2023/064272

§ 371 Date: Sep. 3, 2025

(51) Int. Cl. H04L 67/1095

(52) U.S. Cl. CPC H04L 67/1095

(57) ABSTRACT

Systems and methods for decentralized automatic synchronization of nodes is described, which can comprise a plurality of data centers, connected to an event source node, each data center comprising a memory storing instructions executable by a processor to initiate, based on a condition, a synchronization event; query, a log queue for events processed by at least one of the plurality of data centers; retrieve, from the log queue the events processed in at least one of the plurality of data centers; identify, a discrepancy between the events processed by at least one of the plurality of data centers and events stored in a local event log; determine, a compromised event associated with the event error in the local event log based on the discrepancy; and retrieve, a non-compromised copy of the compromised event from a staging storage of a peer data center.

### TECHNICAL FIELD

The present technology pertains to systems and methods for targeted, decentralized, and autonomous synchronization across nodes in a distributed system or cluster, and to improving synchronization technologies and algorithms in distributed systems to achieve strong consistency across nodes in a system. In particular, but not by way of limitation, the present technology provides systems and methods for autonomous decentralized server synchronization.

### SUMMARY

In numerous aspects, the present disclosure provides a method of synchronizing a node with a peer node in a distributed system, the method comprising initiating, by a node in a distributed system, based on a condition, a synchronization event, wherein each node in the distributed system comprises a landing storage, a staging storage, and a peer staging storage; querying, by the node, a log queue comprising events processed by at least one of a plurality of peer nodes; retrieving, by the node, the events from the log queue; identifying, by the node, a discrepancy between the retrieved events and events stored in a local event log of the node, wherein the discrepancy is indicative of a difference between the retrieved events and the events stored in a local event log of the node; determining, by the node, at least one compromised event in the local event log based on the discrepancy, wherein the compromised event is indicative of an event error; retrieving, by the node, a non-compromised copy of the compromised event from a staging storage of a peer node to resolve the discrepancy, wherein the peer node is selected from the plurality of peer nodes based on a plurality of factors; storing, by the node, the non-compromised copy of the compromised event in the peer staging storage of the node; and transferring, by the node, all events from the peer staging storage of the node to a landing storage of the node.

In various aspects, the method further comprises receiving, by the node, an event from a source node at the landing storage.

In various aspects, the method further comprises processing, by the node, the event; and logging, by the node, the event in the local event log.

In various aspects, the method further comprises copying the event from the landing storage to the staging storage.

In various aspects, the method further comprises logging, by the node, the event in the log queue.

In various aspects, the log queue is a data structure accessible by nodes in the distributed system.

In various aspects, the condition is at least one of an external event, or an implicit invariant condition.

In various aspects, the implicit invariant condition may comprise at least one of a number of events processed, a time lapsed, a time, a date, a time-lapsed since a previous synchronization event, or a frequency of synchronization events.

In various aspects, the missing event is an event that has not been processed or has not been received by the node.

In various aspects, the identifying of the discrepancy comprises executing a checksum comparison between at least one event in the node and a corresponding event in the log queue.

In various aspects, the method further comprises selecting a peer node based on at least one factor of a plurality of factors to retrieve the copy of the compromised event wherein the retrieving is done based on at least one factor of the plurality of factors.

In various aspects, the plurality of factors comprise at least one of a physical proximity of the peer node to the node, a latency between the peer node and the node, compute resource cost for a copying or a transfer of the non-compromised copy of the compromised event from the peer node to the node, the peer node having previously successfully processed the non-compromised copy, the non-compromised copy stored without error in the peer node, the physical proximity of the peer node to the node, the latency between the peer node and the node, the number of processes currently running or in queue at the peer node, the number of calls to the peer node, a history of the peer node, the availability of the non-compromised copy of the compromised event at other peer nodes.

In numerous aspects, the present disclosure provides a non-transitory computer-readable storage medium having embodied thereon a program, the program being executable by a processor to perform a method for synchronizing a node with a peer node in a distributed system comprising initiating, by a node in a distributed system, based on a condition, a synchronization event; retrieving, by the node, from the log queue, the entries of the events processed in at least one of the plurality of peer nodes; identifying, by the node, a discrepancy between the entries and events stored in a local event log of the node, wherein the discrepancy indicates a compromised event in the node; selecting a peer node selected from the plurality of peer nodes based on at least one of a plurality of factors; and retrieving, by the node, a non-compromised version of the compromised event from the peer node.

In various aspects, the non-transitory computer-readable storage medium, wherein the program performs the method, further comprises at least one of querying, by the node, a log queue for entries of events processed by at least one of a plurality of peer nodes, storing, by the node, the non-compromised version of the compromised event in a peer staging storage of the node, or transferring, by the node, all events from the peer staging storage to a landing storage of the node.

In various aspects, the compromised event is an event at the node which is at least one of a corrupted event, an event missing in part, an event missing in full, an unprocessed event, an incorrectly processed event, an event received in an incomplete state, or an event not received at all.

In various aspects, the plurality of factors comprise at least one of a physical proximity of the peer node to the node, a latency between the peer node and the node, compute resource cost for a copying or a transfer of the non-compromised version of the compromised event from the peer node to the node, the peer node having previously successfully processed the non-compromised version, the non-compromised version stored without error in the peer node, the physical proximity of the peer node to the node, the latency between the peer node and the node, the number of processes currently running or in queue at the peer node, the number of calls to the peer node, a history of the peer node, the availability of the non-compromised version of the compromised event at other peer nodes.

In numerous aspects, the present disclosure provides a decentralized automatically synchronizing distributed system, comprising a plurality of data centers, connected to an event source node, wherein each data center of the plurality of data centers comprises a landing storage, a staging storage, and a peer staging storage, each data center comprising a memory storing instructions executable by a processor to initiate, based on a condition, a synchronization event; query, a log queue for events processed by at least one of the plurality of data centers; retrieve, from the log queue the events processed in at least one of the plurality of data centers; identify, a discrepancy between the events processed by at least one of the plurality of data centers and events stored in a local event log, wherein the discrepancy indicates an event error, wherein an event error comprises either an error in an event in the local event log or a missing event from the local event log; determine, a compromised event associated with the event error in the local event log based on the discrepancy; retrieve, a non-compromised copy of the compromised event from a staging storage of a peer data center, wherein the peer node is selected from the plurality of peer nodes based on a plurality of factors; store, the non-compromised copy of the compromised event of the missing event in the peer staging storage; and transfer, all events from the peer staging storage to the landing storage.

In various aspects, the condition is at least one of an external event, or an implicit invariant condition.

In various aspects, the implicit invariant condition may comprise at least one of a number of events processed, a time lapsed, a time, a date, a time-lapsed since a previous synchronization event, or a frequency of synchronization events.

In various aspects, the plurality of factors comprise at least one of a physical proximity of the peer node to the node, a latency between the peer node and the node, compute resource cost for a copying or a transfer of the non-compromised copy of the compromised event from the peer node to the node, the peer node having previously successfully processed the non-compromised copy, the non-compromised copy stored without error in the peer node, the physical proximity of the peer node to the node, the latency between the peer node and the node, the number of processes currently running or in queue at the peer node, the number of calls to the peer node, a history of the peer node, the availability of the non-compromised copy of the compromised event at other peer nodes.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems, and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates one aspect of an architecture of a system for autonomous decentralized server synchronization, according to at least one aspect of the present disclosure.

FIG. 2 illustrates one aspect of an architecture of a system for autonomous decentralized server synchronization and data exchange, according to at least one aspect of the present disclosure.

FIG. 3 illustrates one aspect of a method for autonomous decentralized server synchronization, according to at least one aspect of the present disclosure.

FIG. 4 illustrates another aspect of a method for autonomous decentralized server synchronization, according to at least one aspect of the present disclosure.

FIG. 5 illustrates data flows between a source and various nodes or data centers, according to at least one aspect of the present disclosure.

FIG. 6 illustrates another aspect of a method for autonomous decentralized server synchronization, according to at least one aspect of the present disclosure.

FIG. 7 presents a block diagram of a computer apparatus, according to at least aspect of the present disclosure.

FIG. 8 is a diagrammatic representation of an example system that includes a host machine within which a set of instructions to perform any one or more of the methodologies discussed herein may be executed.

### DESCRIPTION

The following disclosure may provide exemplary systems, devices, and methods for autonomously synchronizing nodes in a distributed system. Although reference may be made to such distributed systems in the examples provided below, aspects are not so limited. That is, the systems, methods, and apparatuses may be utilized for any suitable purpose.

Before discussing specific embodiments, aspects, or examples, some descriptions of terms used herein are provided below.

An “application” may include any software module configured to perform a specific function or functions when executed by a processor of a computer. For example, a “mobile application” may include a software module that is configured to be operated by a mobile device. Applications may be configured to perform many different functions. For instance, a “payment application” may include a software module that is configured to store and provide account credentials for a transaction. A “wallet application” may include a software module with similar functionality to a payment application that has multiple accounts provisioned or enrolled such that they are usable through the wallet application. Further, an “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments or aspects, a message may refer to a packet (e.g., a data packet, a network packet, and/or the like) that includes data. It will be appreciated that numerous other arrangements are possible.

A “communication channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instances comprise a “secure communication channel” or a “tunnel,” either of which may be established in any known manner, including the use of mutual authentication and a session key and establishment of a secure communications session. However, any method of creating a secure communication channel may be used, and communication channels may be wired or wireless, as well as long-range, short-range, or medium-range. By establishing a secure channel, sensitive information related to a payment device (such as account number, CVV values, expiration dates, etc.) may be securely transmitted between the two entities to facilitate a transaction

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

As used herein, the term “system” may refer to one or more computing devices or combinations of computing devices (e.g., processors, servers, client devices, software applications, components of such, and/or the like).

Data synchronization (also referred to as “data sync” or “synchronization”) is one of the most challenging problems in the management and running of distributed systems. Data synchronization may refer to synchronization across one or multiple nodes, it may refer to one part or a complete synchronization process, it may refer to a triggering of synchronization across one or more nodes, or refer to information retrieval or determination processes that are part of a synchronization, such as determining by one node whether synchronization is necessary, or identifying discrepancies between nodes, or whether there are compromised events or files, queries for information or data, as well as the copying, retrieving, or moving of files across a distributed system, between nodes, or within nodes, or any combination of these in addition to any of the techniques described in this document in relation hereto.

There are two primary approaches to implement data syncs across servers, the first is using a central synchronization entity, such as a central synchronization server. However this approach introduces a single point of failure and weakens the presumed goals and benefits of a distributed system. The second approach is to implement a synchronization model that provides synchronization to a level of ‘eventual consistency’ which ensures synchronization between two sides or nodes at ‘any point in the future’. This means there could be substantial time periods where the data servers, centers, or nodes are not in sync but where the synchronization occurs that they eventually become in sync at some point of time. This eventual consistency may suffice where applications are not data critical, but does not suffice for areas that are very data sensitive/data critical, where there is a requirement to ensure that there is no loss or lag in updating information. Therefore, in data critical applications strong consistency is required to ensure successful processing. But achieving strong consistency in distributed systems is a non-trivial task.

Disclosed are systems and methods of data synchronization in distributed systems across nodes, computing devices, servers, databases, data sites, or data centers (all these terms may be used herein collectively and interchangeably within the architecture of a distributed system or cluster) that achieve strong consistency between n different data sites without the need of any central coordination entity. Removal of a central coordination entity produces a more resilient system without any single point of failure.

The disclosed technologies, systems, and methods rely upon time-coordinated data synchronization to achieve strong consistency across nodes or data sites participating in the system, i.e., ideal state strong consistency at every point of time, where all participating nodes or clusters are always in complete sync.

The advantages of strong consistency solves various synchronization issues associated with distributed systems, the first is the ability to autonomously trigger data synchronization. Autonomous triggering of synchronization may be triggered based on external events where all the participating nodes may then engage in synchronization activities. This is particularly useful in the anticipation of specific events such as server downtimes. The second, is that time-coordinated data synchronization allows the building and implementation of autonomous implicit invariant time-based synchronization in a distributed system. This means that whenever an invariant is violated, for example the number of events processed by one or more nodes, a synchronization protocol is automatically triggered and synchronization autonomously brings the distributed system or cluster to a state where the invariant is not violated or is satisfied and achieving strong consistency. Both of these use cases would not be possible with an eventual consistency model.

One example of the benefits of the technologies disclosed herein is the improved efficiency of transaction processing. This can be illustrated in a distributed system containing hundreds of nodes, if processing is undertaken in one node, and that node goes down or is attacked by a malicious actor, then the transactions may be wiped out from the system. However, in the proposed distributed system, if data is synchronized where the system is in a state of strong consistency, where the nodes in the system possess the same events and information, then one node going down will not affect the data that is available to all the other nodes, since the distributed system has maintained strong consistency between all the nodes or between all designated nodes.

Furthermore, because the presented technologies allows each node to discover what local events, data, or files have been missed, corrupted, or otherwise compromised, then it allows that node to only retrieve and synchronize that particular event or data that it has identified as compromised, and does not require synchronization of a whole database, or for all data or information in the node. Instead the technologies herein allow for targeted synchronization that only copy or transfer files across a distributed system from one node or another once a check has been completed, discrepancies have been identified and/or compromised events have been determined. This ability to target synchronization and control when it occurs, allows a distributed system to not expend any processing, storage, networking or memory resources for unnecessary synchronization, transfer, or copying of files across the system.

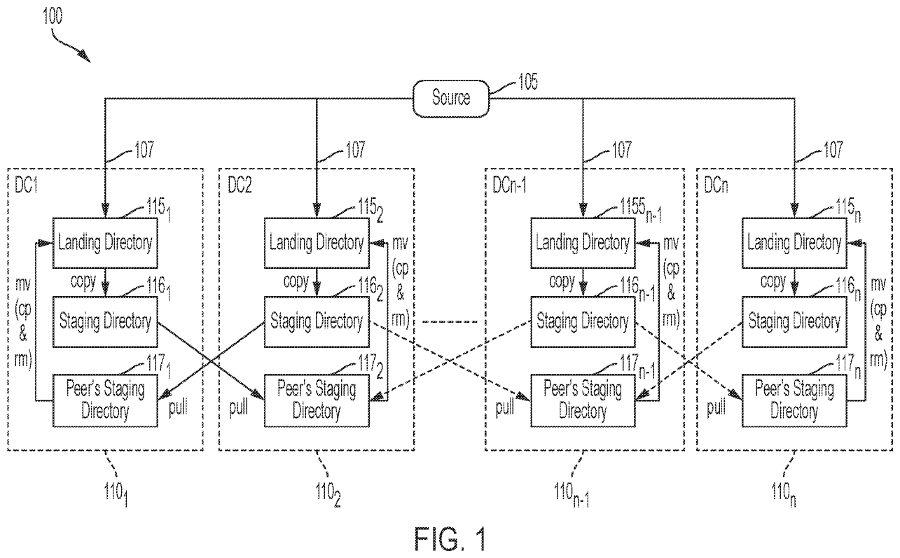

FIG. 1 illustrates one aspect of an architecture of a system for autonomous decentralized server synchronization, according to at least one aspect of the present disclosure. System 100 may include multiple nodes, computing devices, servers, databases, data sites, or data centers 110₁-110ₙ (hereinafter collectively referred to as “data centers”, “nodes”, or “data sites”). The systems and methods disclosed aim to achieve strong consistency across all data centers 110₁-110ₙ. Data centers 110₁-110ₙ may be located in various locations, or may be located in the same vicinity or geographical space. Each data center may include various file directories or separate storages/storage systems, databases, or storage drives/disks, virtual or physical storage mechanisms or devices. For instance each data center 110₁-110ₙ may include a landing directory or landing storage 115₁-115ₙ (referred to herein as either “landing directory”, “landing location”, or “landing storage”). Landing directory 115₁-115ₙ may receive an event 107 from a source node, source server, or source location 105 (these are interchangeable and may be referred to herein as “source”). An event 107 as discussed herein may include a request, a process, a file, a transaction, data, a package of data, a data object, an executable file, a query, applet, application or other transmitted object or data object (these hereinafter referred to collectively as “event”) that is received from a source, such as source 105. When a source 105 transmits an event 107, it may do so to one or all the data centers 110₁-110ₙ, and once data center 110₁-110ₙ receives event 107, it receives it at landing directory 115₁-115ₙ,.

Each data center 110₁-110ₙ also includes a staging directory or staging storage 116₁-116ₙ (referred to herein as either “staging directory”, “staging location”, or “staging storage”). Once nodes 110₁-110ₙ receive event 107, in several aspects they are initially received at landing directory 115₁-115ₙ, and processed there, before being copied to staging directory 116₁-116ₙ. In other aspects, event 107 is received at landing directory 115₁-115ₙ, and then either copied or transferred to staging directory 116₁-116ₙ where it is processed or served. In several aspects, each of data centers 110₁-110ₙ also include a peer staging directory or peer staging storage 1171-117ₙ (referred to herein as either “staging directory”, “staging location”, or “staging storage”), which is used to receive events, data, or files 107, from staging directory 116₁-116ₙ of another data center 110₁-110ₙ. Once event 107, file, or other data is received at peer staging directory 117₁-117ₙ from staging directory 116₁-116ₙ of another data center 110₁-110ₙ, it may then be copied or transferred to landing directory 115₁-115ₙ, of the receiving data center 110₁-110ₙ where event, data or file 107 is then treated like any other event and is copied or transferred to staging directory 116₁-116ₙ from landing directory 115₁-115ₙ of receiving data center 110₁-110ₙ as already described herein. Any one of nodes 110₁-110ₙ, landing directory 115₁-115ₙ, staging directory 116₁-116ₙ, or peer staging directory 117₁-117ₙ may comprise physical devices, computing hardware, storage systems or hardware, or virtual ones, or a combination thereof.

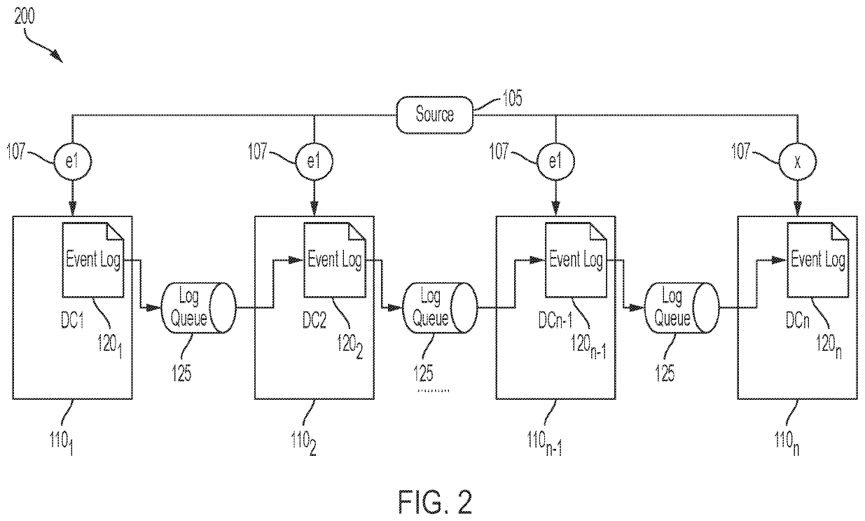

FIG. 2 illustrates one aspect of an architecture of a system for autonomous decentralized server synchronization and data exchange, according to at least one aspect of the present disclosure. With Reference primarily to FIG. 2 and together with FIG. 1, each datacenter 110₁-110ₙ may receive event 107. Each datacenter 110₁-110ₙ may also include a local event log 120₁-120ₙ. In various aspects once event 107 is received at landing directory 115₁-115ₙ, and/or processed, and/or transferred, or copied to staging directory 116₁-116ₙ, event 107 may be logged along with all its details, in local event log 120₁-120ₙ. An event log 120₁-120ₙ may contain information about event 107 including timestamps, size of files, types of files, file formats, names, security, or related information. Data centers 110₁-110ₙ may transfer the information logged about event 107 from event log 120₁-120ₙ into a shared log queue 125 that is accessible by all data centers 110₁-110ₙ. Log queue 125 allows data centers 110₁-110ₙ to publish information on local events to a shared data structure that is hosted across various nodes 110₁-110ₙ in distributed system 200, or 100.

For each data center 110₁-110ₙ shared log queue 125 serves as a public data structure that is accessible to all data centers 110₁-110ₙ. Updates to the data structure regarding events at a particular node 110₁-110ₙ can only be made by that particular data center 110₁-110ₙ but the information that is written by a particular node 110₁-110ₙ in shared log queue 125 may be read by the other nodes 110₁-110ₙ with access to log queue 125. Data centers 110₁-110ₙ use this data structure to identify any events 107 that they might have missed or that have otherwise been compromised. Identification of missing events 107 may cause system 100, 200, to execute a data sync algorithm. In one aspect, log queue 125 is a shared data structure and allows, via a publisher subscriber model, the publication of information on the shared data structure, as well as reads from the shared data structure by the nodes or data centers 110₁-110ₙ with access to the log queue 125. The shared single data structure may be hosted on or across various nodes 110₁-110ₙ.

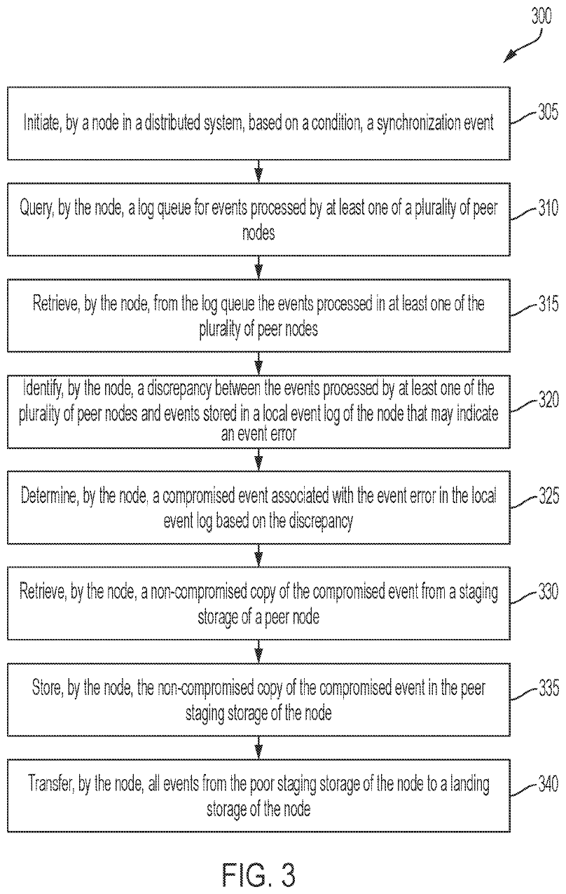

FIG. 3 illustrates one aspect of a method for autonomous decentralized server synchronization, according to at least one aspect of the present disclosure. Discussion of method 300 will reference primarily FIG. 3, and together with FIG. 1-2. A node, for example may be any one of data centers 110₁-110ₙ in the distributed system, e.g., systems 100 and 200, and may initiate 305 a data synchronization, based on a condition. In the discussion relating to FIG. 1-8, the node initiating and undertaking the synchronization is referred to as node 110₁, while other nodes in the distributed system, such as systems 100, 200, are referred to as 110₂-110ₙ. Of course any node of 110₁-110ₙ may undertake any of these processes described herein.

Initiation 305 may be autonomous based on a condition being satisfied that triggers the data synchronization. The condition triggering the synchronization may be an external event, for example server events such as downtimes, upcoming maintenance, or problems across the distributed system, 100, 200, such as known mass missed transmissions or faulty events. The condition causing the initiation 305 may also be the satisfaction of implicit criteria that trigger the event, for example, criteria may be set or configured that node 110₁ will initiate 305 a synchronization after receiving and/or processing n number of events, wherein processed events may be events 107 as shown in FIG. 1-2. Data syncs may also be based on time frequencies, or time-lapsed since a last data sync. Other implicit criteria may be time-based, such as time-lapsed since a last synchronization. Data syncs may also be automatically triggered or initiated across multiple nodes 110₁-110ₙ in the system, 100, 200 at specific times or dates, these may for example be pre-set or pre-defined, such as data syncs autonomously initiating at ‘9 pm GMT’.

With continued reference to FIG. 3, together with FIG. 1-2, once a synchronization is initiated 305, node or data center 110₁ queries 310 a shared data structure or log queue 125, for events 107 that have been processed by at least one of a plurality of peer nodes 110₂-110 ₙ. Querying 310 may include requesting and/or receiving information, data, and/or metadata from log queue 125 about event(s) 107 as written or published into log queue 125 by other nodes 110₂-110ₙ. Details that may be requested and retrieved by querying 310 may include and are not limited to data or metadata related to event names, identifiers, numbers, sizes including any file sizes, number of files, file types, or formats. The querying node 110₁ may then receive or retrieve 315 from log queue 125, events 107 processed, or a list of events 107 processed in at least one of the plurality of nodes, such as at least one of data centers 110₂-110ₙ along with associated event 107 data or metadata. In various aspects, requesting node 110₁ may identify 320 a discrepancy between events 107 processed by at least one of the plurality of peer nodes 110₂-110ₙ and events 107 stored in a local event log of requesting node 110₁, such as event log 120. This discrepancy may indicate an event error. The discrepancy may be one between the events 107 processed by at least one of the plurality of nodes 110₂-110ₙ and logged in the log queue 125, and between events 107 stored in a local event log 120 of node 110₁.

This identifying 320 may include comparing events 107 in log queue 125 to the events processed in local event log 120, this may include comparing the number of events 107 in the file lists of local event log 120 and the log queue 125 and ascertaining whether they are the same. Comparisons may also be made between files or events 107 in local event log 120 and the log queue 125, regarding file size, identifiers, and composition, format, date, current state of events 107 as well as other attributes. If discrepancies are identified 320 then this may indicate a missing event, i.e., a discrepancy in the number of events. In several aspects, a backwards identification may occur, where node 110₁ identifies a discrepancy which indicates not an error in local event 120 but an error in log queue 125, and this may trigger a notification to another node 110₂-110ₙ, or writing/publishing into log queue 125 by node 110₁ to mark or flag the discrepancy. However, identifying 320 a discrepancy does not necessarily mean that there is an event error, but merely be an indication of a compromised event. The existence of a compromised event is then confirmed or determined 325 by node 110₁.

With continued reference to FIG. 3, together with FIG. 1-2, once a discrepancy is identified 320, node 110₁ determines 325, a compromised event 107 that is associated with the event error. For example if it is determined 325 that an event 107 is compromised, then recovery steps may be initiated. Determining 325 by a node 110₁ a compromised event 107 associated with the event error may mean determining that event, data or file 107, is corrupted, is missing, or was received or processed incorrectly or with error(s). Determining 325 may be undertaken by comparing the contents of events 107 in node 110₁ with events 107 of nodes 110₂-110ₙ. In most aspects, the identification 320, identifies a difference in the number of events between the event log 120 of node 110₁ and the data from log queue 125 of nodes 110₂-110ₙ. Once a discrepancy in the number of events is identified 320, then the compromised event 107 is determined 325, by comparing the contents or other attributes of one or more events 107 in node 110₁ and one or more events 107 in log queue 125 as published by at least one of nodes 110₂-110ₙ. Determination 325 may involve a comparison of the contents of events 107 in the local event log 120, i.e., in the node 110₁, and those events as published in log queue 125. Comparisons of the contents of events may include error detection techniques such as a checksum comparison between events 107 in the log queue 125 and local event log 120. In some aspects, determining 325 may involve calculating differences between events 107 in event log 120 and in log queue 125, for example, different file sizes, different checksum hashes, or differences in event identifiers in the two logs. In some aspects, there is no separate determination 325 process involved and both identification 320 and determination 325 are combined together.

Continuing to refer to FIG. 3 together with FIG. 1-2, in various instances, where it is determined 325 that an event 107 is compromised, for example, missing or corrupted, then node 110₁ may retrieve 330 a non-compromised copy of compromised event 107 from a staging storage 116ₓ of a peer node 110ₓ. A non-compromised event or a non-compromised copy of an event, is an event that was received by another node, such as a peer node 110ₓ, and processed correctly by that node. Peer node 110ₓ may be any of data centers 110₂-110ₙ. If node 110₁ has various nodes 110₂-110ₙ it can use as a peer node 110ₓ to retrieve 330 a non-compromised copy of event 107 from, it may select peer node 110ₓ from nodes 110₂-110ₙ based on several factors, including latency or potential latency, traffic to and from peer node 110ₓ, geographical location, geographical proximity or distance between receiving node 110₁ and peer node 110ₓ, and other networking issues, settings or configurations to determine that one peer node 110ₓ is to be used over others. Log queue 125 will also contain relevant information that may be used to determine where event 107 or a non-compromised copy of event 107 may be pulled, copied, or retrieved from. In several instances any node 110₂-110ₙ of distributed system, 100, 200, which contains the non-compromised copy of the compromised event 107 may be used.

Continuing to refer to FIG. 3 together with FIG. 1-2, when a non-compromised copy of the compromised event is retrieved 330 from peer node 110ₓ, in most aspects, the retrieval is from staging directory 116ₓ of peer node 110ₓ, and pulled, transmitted, or downloaded into a peer staging directory 117₁ of receiving node 110₁. This means that if event 107 is compromised whether because it was not received correctly, or was corrupted, processed incorrectly or otherwise, the node does not need to go to a central entity or server to retrieve event 107 or a copy of event 107, or to find out in which node it is stored, since node 110₁ is able to access and read shared log queue 125 and compare it to its local event log 120 to identify 320 and/or determine 325 discrepancies between the two and determine 325 whether any of events 107 are compromised. In many instances the non-compromised copy of the compromised event 107 is retrieved from a designated backup server, datacenter, location or node 110₂-110 ₙ. Once a copy of event 107 is retrieved 330 from peer node 110ₓ, it is then stored 335 by node 110₁ in the peer stage storage of the node. The peer staging storage may be peer staging directory 117₁ receiving node 110₁. Finally, in several instances, event 107 is copied or transferred 340 from peer staging storage or directory 117₁ into a landing storage 115₁ of node 110₁.

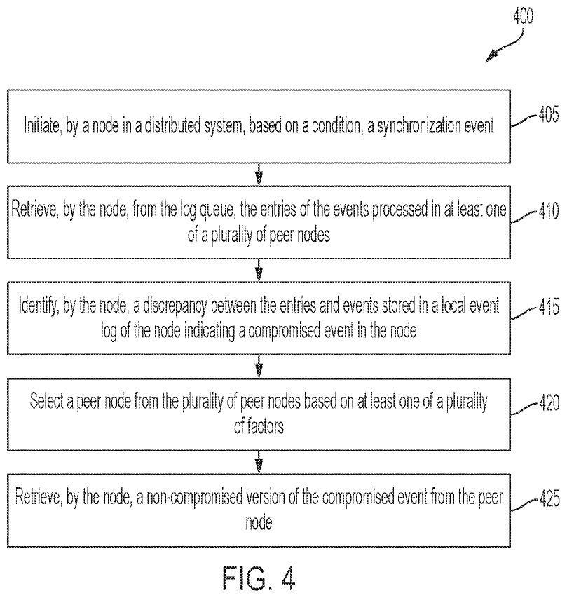

FIG. 4 illustrates another aspect of a method for autonomous decentralized server synchronization, according to at least one aspect of the present disclosure. With reference primarily to FIG. 4 together with FIG. 1-3, method 400 may commence with node 110₁ initiating 405, based on a condition, a data synchronization, with other nodes 110₂-110ₙ in a distributed system, 100, 200. Node 110₁ may retrieve 410 from log queue 125, entries of events 107 processed in at least one of a plurality of peer nodes 110ₓ in distributed system, 100, 200. Node 110₁ may identify 415 a discrepancy between the entries in a log queue 125, and events 107 stored in a local event log 120 of node 110₁ indicating an event error.

Method 400 is similar to method 300 described in FIG. 3, and may include all processes and techniques described in relation to FIG. 3, except that in method 400, identification 415 of a discrepancy comprises a determining of a compromised event that triggers recovery steps. Once a discrepancy indicating a compromised event 107 is identified 415, then node 110₁ may select 420 a peer node 110ₓ from the plurality of peer nodes 110₂-110ₙ based on at least one of a plurality of factors. These factors may include any of the factors to select a peer node as discussed relating to FIG. 3. Node 110₁ may then retrieve 425 a non-compromised version of the compromised event 107 from peer node 110ₓ. Any of the additional techniques described regarding method 300, FIG. 3 may be incorporated in any order into method 400.

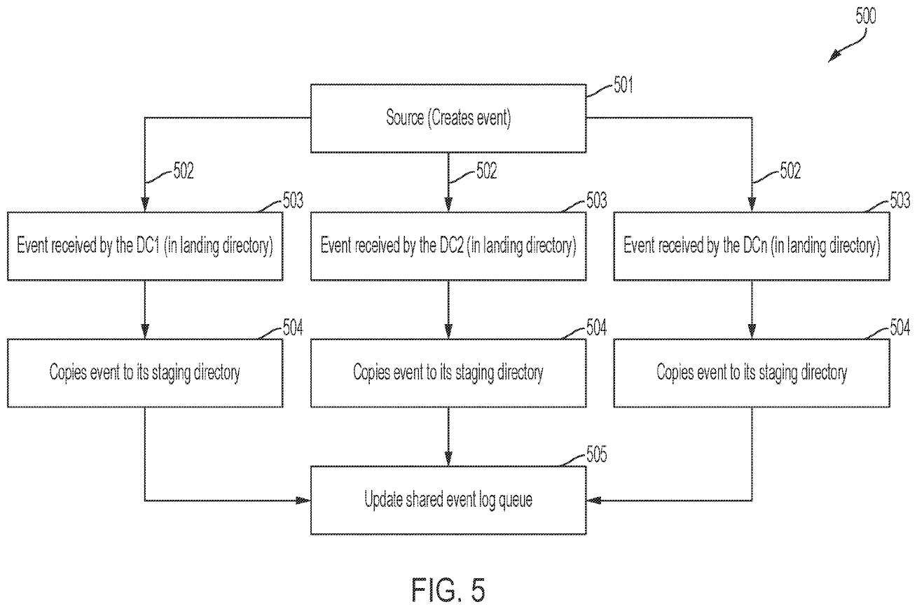

FIG. 5 illustrates data flows between a source and various nodes or data centers, according to at least one aspect of the present disclosure. With reference primarily to FIG. 5 together with FIG. 1-2, data flows 500 may include a source, for example source 105, creating 501 and transmitting 502 a request, a file, process, executable, query, application or other event, for example event 107, to one or more data centers or nodes, for example data centers 110₁-110ₙ. The source may emit 502 event 107 to all data sites 110₁-110ₙ with best effort delivery guarantee. Best effort delivery guarantee in this context means that there exists a contract between source and destination, where if because of reasons out of control of a source, e.g., source 105, the event 107 is not received by a destination, for example data centers 110₁-110ₙ. It is not the responsibility of source 105 to resend the event. Essentially, no re-transmission after failure occurs in a best effort delivery guarantee context. These events 107 are received 503 by these data centers 110₁-110ₙ, in most embodiments in the landing directory, for example landing directory or landing storage 115₁-115ₙ, and are generally copied 504 to a local staging directory, for example staging directory 116₁-116ₙ. Once processing of an event is complete on a node and it has been transferred to a local staging directory of each node or data center, each node or data center then updates 505 the shared event log queue, for example log queue 125, FIG. 2. Processing may occur in the landing storage/directory or the staging storage/directory depending on the aspect.

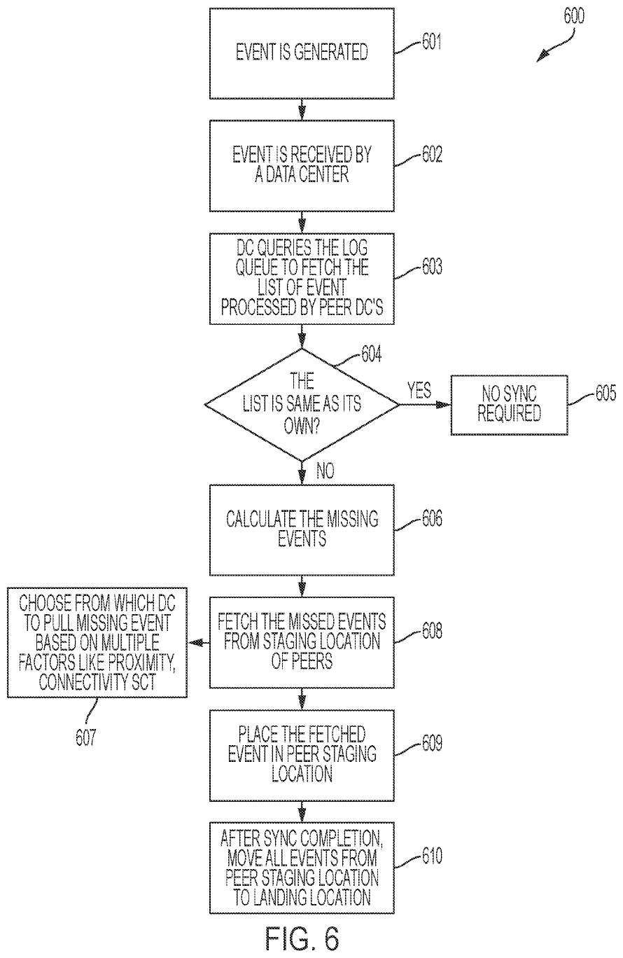

FIG. 6 illustrates another aspect of a method for autonomous decentralized server synchronization, according to at least one aspect of the present disclosure. With reference primarily to FIG. 6 together with FIG. 1-2, method 600 may commence with the generation 601 of an event, this may be an event that is transmitted to a node or data center, for example data centers 110₁-110ₙ, and may be an event that is an external synchronization event, or an implicit invariant (i.e., satisfaction of implicit or preset conditions) based data synchronization event that causes the data centers 110₁-110ₙ to initiate a synchronization check across the distributed system, for example systems 100 and 200. The event is received 602 by at least one of the data centers 110₁-110ₙ which starts a synchronization check across the servers or nodes 110₁-110ₙ. The synchronization check is across the data centers 110₁-110ₙ, and in various instances, is an explicit operation performed by all data centers at pre-defined time intervals or in response or based on the aforementioned event to achieve strong consistency among all data sites 110₁-110ₙ at any given point in time.

With continued reference primarily to FIG. 6 together with FIG. 1-2, each of the data sites 110₁-110ₙ query 603 the log queue, for example log queue 125 to fetch the list of events processed by other data centers 110₁-110ₙ. A synchronization check process will run 604 on all the data sites 110₁-110ₙ to identify or determine that the number (and checksum) of events in the file-list of all the data sites 110₁-110ₙ is the same. For each node running 604 the sync check, if it determines that the events 107 in the shared file-list, for example log queue 125 is the same as its own local file list, for example event log 120, then process 600 may end or be terminated 605 in that particular node 110₁. For each node where the file list is different from the local file list, then the node 110₁ proceeds to calculate or determine the missing event 107 or determine the type of error in an event 107, these may be compromised events that are missing or corrupted from the data center 110₁. The data center 110₁ calculates or determines 606 the missing event 107, and fetches 608 the missed events 107 from the staging location of peer nodes 110₂-110ₙ, generally from a staging location 116₂-116 ₙ. The node 110₁ may choose or select 607 from which data center or node 110₂-110ₙ it fetches 608 the data or event 107 from, based on at least one of multiple factors, such as proximity of peer node 110ₓ, connectivity, connection quality, and other factors disclosed in relation to methods 300-400.

Once a copy of event 107 is fetched 608 from a peer node 110ₓ it is placed 609 in the receiving node's peer staging location 117₁, and then after synchronization is completed, and all events have been fetched from the the various peer nodes in the distributed system, 100, 200, which had uncompromised versions of events 107, that were compromised in the local nodes, then all events 107 that were fetched 608 and placed 609 in the peer staging location 117₁ of node 110₁, and copied, transferred, or moved 610 into the landing location 115₁ of the receiving or local node 110₁; after which it may be processed normally like any other event 107 received by any node. During the moving 610 into the landing directory 115₁, this action may be halted, paused or canceled, if an event 107 is being received from source 105, to avoid data corruption or data duplication (if the same event 107 is being received, or events 107 relating to the same application are being received from a source 105). Every data event 107 is processed atomically.

In various aspects, if the synchronization lag meets and/or exceeds a predetermined threshold, for example the number of files that have not been synchronized across a node or a system, or the time period lapsed since a last sync event, or the total size of unsynchronized files across a node or a system, then an optimization technique may be automatically and autonomously deployed. In addition to the examples provided, this optimization technique may be deployed in example scenarios including if all or a majority of datacenters 110₁-110ₙ are running behind in their synchronization, then the optimization technique would utilize the datacenter 110₁-110ₙ node that is least behind, (or that is most ahead in synchronizations) in the synchronization lag, to broadcast missing/delayed events to all the lagging datacenters. This is a more efficient process, than events being propagated via the peers datacenters as described in this document, since when the datacenter 110₁-110ₙ nodes have major synchronization lags, and are at different levels of synchronization, then multiple levels of data hops (movement via multiple peers) will be required to reach all the datacenters and synchronize a node with the rest of the system, whereas broadcasting the events will cover the lag amongst all the lagging datacenters at once.

To identify or determine whether the synchronization lag meets or exceeds a threshold, and whether a broadcast should be performed, each datacenter 110₁-110ₙ node can quantify the lag by comparing the events that are processed by a peer datacenter 110₁-110ₙ node and the event that is processed by itself, if the difference in the event properties (for example, a timestamp, file_id etc.) is above a threshold that is preset or predetermined. The threshold may be preset manually by an administrator for example, or it may be set autonomously and automatically by the system based on historical data and patterns, wherein these patterns may be analyzed and set and modify the thresholds, as well as what the thresholds apply to (for example time lapsed, file numbers, total file size that is unsynchronized etc.). This calculation to identify or determine whether the synchronization lag meets or exceeds a threshold is undertaken, in most aspects, simultaneously with the calculation 606 of the missing events to be synced.

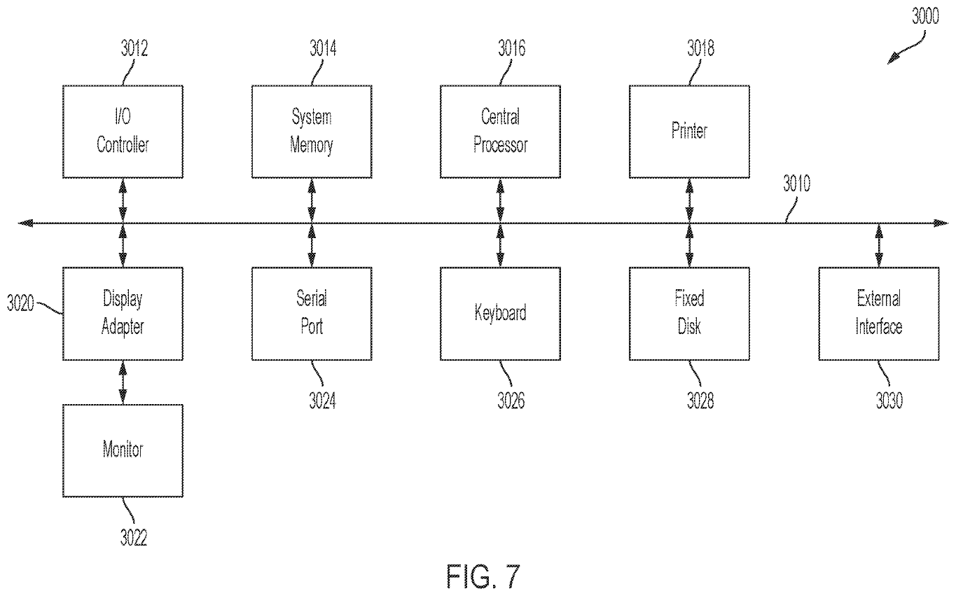

FIG. 7 is a block diagram of a computer apparatus 3000 with data processing subsystems or components, which a set of instructions to perform any one or more of the methodologies discussed herein may be executed, according to at least one aspect of the present disclosure. The subsystems shown in FIG. 7 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

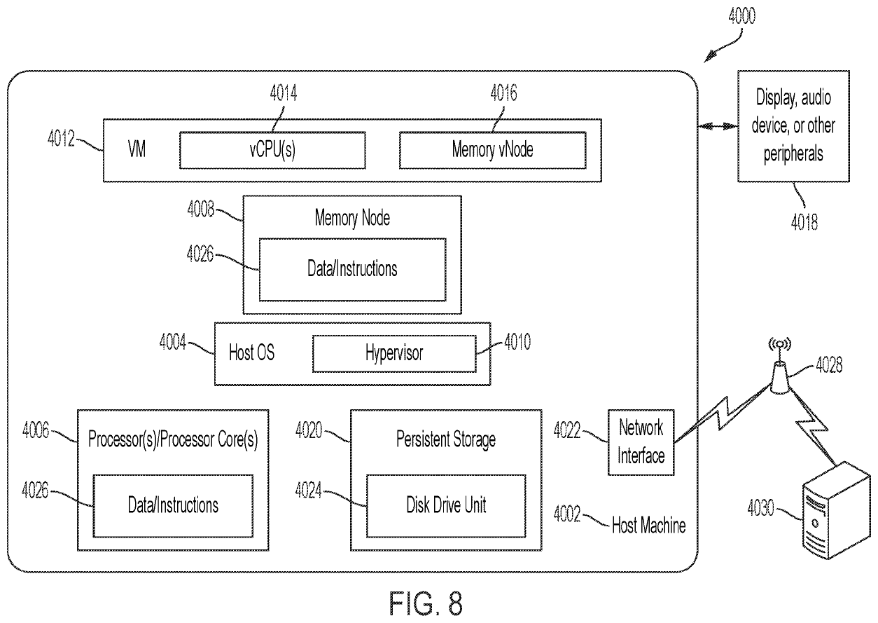

FIG. 8 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 3002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine.

Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM.

Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

Clause 1. A method of synchronizing a node with a peer node in a distributed system, the method comprising initiating, by a node in a distributed system, based on a condition, a synchronization event, wherein each node in the distributed system comprises a landing storage, a staging storage, and a peer staging storage; querying, by the node, a log queue comprising events processed by at least one of a plurality of peer nodes; retrieving, by the node, the events from the log queue; identifying, by the node, a discrepancy between the retrieved events and events stored in a local event log of the node, wherein the discrepancy is indicative of a difference between the retrieved events and the events stored in a local event log of the node; determining, by the node, at least one compromised event in the local event log based on the discrepancy, wherein the compromised event is indicative of an event error; retrieving, by the node, a non-compromised copy of the compromised event from a staging storage of a peer node to resolve the discrepancy, wherein the peer node is selected from the plurality of peer nodes based on a plurality of factors; storing, by the node, the non-compromised copy of the compromised event in the peer staging storage of the node; and transferring, by the node, all events from the peer staging storage of the node to a landing storage of the node.

Clause 2. The method of claim 1, further comprising receiving, by the node, an event from a source node at the landing storage.

Clause 3. The method of any of clauses 1-2, further comprising processing, by the node, the event; and logging, by the node, the event in the local event log.

Clause 4. The method of any of clauses 1-3, further comprising copying the event from the landing storage to the staging storage.

Clause 5. The method of any of clauses 1-4, further comprising logging, by the node, the event in the log queue.

Clause 6. The method of any of clauses 1-5, wherein the log queue is a data structure accessible by nodes in the distributed system.

Clause 7. The method of any of clauses 1-6, wherein the condition is at least one of an external event, or an implicit invariant condition.

Clause 8. The method of any of clauses 1-7, wherein the implicit invariant condition may comprise at least one of a number of events processed, a time lapsed, a time, a date, a time-lapsed since a previous synchronization event, or a frequency of synchronization events.

Clause 9. The method of any of clauses 1-8, wherein the missing event is an event that has not been processed or has not been received by the node.

Clause 10. The method of any of clauses 1-9, wherein the identifying of the discrepancy comprises executing a checksum comparison between at least one event in the node and a corresponding event in the log queue.

Clause 11. The method of any of clauses 1-10, further comprising selecting a peer node based on at least one factor of a plurality of factors to retrieve the copy of the compromised event wherein the retrieving is done based on at least one factor of the plurality of factors.

Clause 12. The method of any of clauses 1 -11 wherein the plurality of factors comprise at least one of a physical proximity of the peer node to the node, a latency between the peer node and the node, compute resource cost for a copying or a transfer of the non-compromised copy of the compromised event from the peer node to the node, the peer node having previously successfully processed the non-compromised copy, the non-compromised copy stored without error in the peer node, the physical proximity of the peer node to the node, the latency between the peer node and the node, the number of processes currently running or in queue at the peer node, the number of calls to the peer node, a history of the peer node, the availability of the non-compromised copy of the compromised event at other peer nodes.

Clause 13. A non-transitory computer-readable storage medium having embodied thereon a program, the program being executable by a processor to perform a method for synchronizing a node with a peer node in a distributed system comprising initiating, by a node in a distributed system, based on a condition, a synchronization event; retrieving, by the node, from the log queue, the entries of the events processed in at least one of the plurality of peer nodes; identifying, by the node, a discrepancy between the entries and events stored in a local event log of the node, wherein the discrepancy indicates a compromised event in the node; selecting a peer node selected from the plurality of peer nodes based on at least one of a plurality of factors; and retrieving, by the node, a non-compromised version of the compromised event from the peer node.

Clause 14. The non-transitory computer-readable storage medium of clause 13, wherein the program performs the method further comprising at least one of querying, by the node, a log queue for entries of events processed by at least one of a plurality of peer nodes, storing, by the node, the non-compromised version of the compromised event in a peer staging storage of the node, or transferring, by the node, all events from the peer staging storage to a landing storage of the node.

Clause 15. The non-transitory computer-readable storage medium of any of clauses 13-14, wherein the compromised event is an event at the node which is at least one of a corrupted event, an event missing in part, an event missing in full, an unprocessed event, an incorrectly processed event, an event received in an incomplete state, or an event not received at all.

Clause 16. The non-transitory computer-readable storage medium of any of clauses 13-15, wherein the plurality of factors comprise at least one of a physical proximity of the peer node to the node, a latency between the peer node and the node, compute resource cost for a copying or a transfer of the non-compromised version of the compromised event from the peer node to the node, the peer node having previously successfully processed the non-compromised version, the non-compromised version stored without error in the peer node, the physical proximity of the peer node to the node, the latency between the peer node and the node, the number of processes currently running or in queue at the peer node, the number of calls to the peer node, a history of the peer node, the availability of the non-compromised version of the compromised event at other peer nodes.

Clause 17. A decentralized automatically synchronizing distributed system, comprising a plurality of data centers, connected to an event source node, wherein each data center of the plurality of data centers comprises a landing storage, a staging storage, and a peer staging storage, each data center comprising a memory storing instructions executable by a processor to initiate, based on a condition, a synchronization event; query, a log queue for events processed by at least one of the plurality of data centers; retrieve, from the log queue the events processed in at least one of the plurality of data centers; identify, a discrepancy between the events processed by at least one of the plurality of data centers and events stored in a local event log, wherein the discrepancy indicates an event error, wherein an event error comprises either an error in an event in the local event log or a missing event from the local event log; determine, a compromised event associated with the event error in the local event log based on the discrepancy; retrieve, a non-compromised copy of the compromised event from a staging storage of a peer data center, wherein the peer node is selected from the plurality of peer nodes based on a plurality of factors; store, the non-compromised copy of the compromised event of the missing event in the peer staging storage; and transfer, all events from the peer staging storage to the landing storage.

Clause 18. The system of clause 17, wherein the condition is at least one of an external event, or an implicit invariant condition.

Clause 19. The system of clauses 17-18, wherein the implicit invariant condition may comprise at least one of a number of events processed, a time lapsed, a time, a date, a time-lapsed since a previous synchronization event, or a frequency of synchronization events.

Clause 20. The system of clauses 17-19, wherein the plurality of factors comprise at least one of a physical proximity of the peer node to the node, a latency between the peer node and the node, compute resource cost for a copying or a transfer of the non-compromised copy of the compromised event from the peer node to the node, the peer node having previously successfully processed the non-compromised copy, the non-compromised copy stored without error in the peer node, the physical proximity of the peer node to the node, the latency between the peer node and the node, the number of processes currently running or in queue at the peer node, the number of calls to the peer node, a history of the peer node, the availability of the non-compromised copy of the compromised event at other peer nodes.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.” With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect.

Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A method of synchronizing a node with a peer node in a distributed system, the method comprising:
initiating, by a node in a distributed system, based on a condition, a synchronization event, wherein each node in the distributed system comprises a landing storage, a staging storage, and a peer staging storage;
querying, by the node, a log queue comprising events processed by at least one of a plurality of peer nodes;
retrieving, by the node, the events from the log queue;
identifying, by the node, a discrepancy between the retrieved events and events stored in a local event log of the node, wherein the discrepancy is indicative of a difference between the retrieved events and the events stored in a local event log of the node;
determining, by the node, at least one compromised event in the local event log based on the discrepancy, wherein the compromised event is indicative of an event error;
retrieving, by the node, a non-compromised copy of the compromised event from a staging storage of a peer node to resolve the discrepancy, wherein the peer node is selected from the plurality of peer nodes based on a plurality of factors;
storing, by the node, the non-compromised copy of the compromised event in the peer staging storage of the node; and
transferring, by the node, all events from the peer staging storage of the node to a landing storage of the node.

2. The method of claim 1, further comprising:
receiving, by the node, an event from a source node at the landing storage.

3. The method of claim 2, further comprising:
processing, by the node, the event; and
logging, by the node, the event in the local event log.

4. The method of claim 2, further comprising:
copying the event from the landing storage to the staging storage.

5. The method of claim 3, further comprising:
logging, by the node, the event in the log queue.

6. The method of claim 1, wherein the log queue is a data structure accessible by nodes in the distributed system.

7. The method of claim 1, wherein the condition is at least one of an external event, or an implicit invariant condition.

8. The method of claim 7, wherein the implicit invariant condition may comprise at least one of a number of events processed, a time lapsed, a time, a date, a time-lapsed since a previous synchronization event, or a frequency of synchronization events.

9. The method of claim 1, wherein the missing event is an event that has not been processed or has not been received by the node.

10. The method of claim 1, wherein the identifying of the discrepancy comprises executing a checksum comparison between at least one event in the node and a corresponding event in the log queue.

11. The method of claim 1, further comprising:
selecting a peer node based on at least one factor of a plurality of factors to retrieve the copy of the compromised event wherein the retrieving is done based on at least one factor of the plurality of factors.

12. The method of claim 1, wherein the plurality of factors comprise at least one of a physical proximity of the peer node to the node, a latency between the peer node and the node, compute resource cost for a copying or a transfer of the non-compromised copy of the compromised event from the peer node to the node, the peer node having previously successfully processed the non-compromised copy, the non-compromised copy stored without error in the peer node, the physical proximity of the peer node to the node, the latency between the peer node and the node, the number of processes currently running or in queue at the peer node, the number of calls to the peer node, a history of the peer node, the availability of the non-compromised copy of the compromised event at other peer nodes.

13. A non-transitory computer-readable storage medium having embodied thereon a program, the program being executable by a processor to perform a method for synchronizing a node with a peer node in a distributed system comprising:
initiating, by a node in a distributed system, based on a condition, a synchronization event;
retrieving, by the node, from the log queue, the entries of the events processed in at least one of the plurality of peer nodes;
identifying, by the node, a discrepancy between the entries and events stored in a local event log of the node, wherein the discrepancy indicates a compromised event in the node;
selecting a peer node selected from the plurality of peer nodes based on at least one of a plurality of factors; and
retrieving, by the node, a non-compromised version of the compromised event from the peer node.

14. The non-transitory computer-readable storage medium of claim 13, wherein the program performs the method further comprising at least one of:
querying, by the node, a log queue for entries of events processed by at least one of a plurality of peer nodes,
storing, by the node, the non-compromised version of the compromised event in a peer staging storage of the node, or
transferring, by the node, all events from the peer staging storage to a landing storage of the node.

15. The non-transitory computer-readable storage medium of claim 13, wherein the compromised event is an event at the node which is at least one of a corrupted event, an event missing in part, an event missing in full, an unprocessed event, an incorrectly processed event, an event received in an incomplete state, or an event not received at all.

16. The non-transitory computer-readable storage medium of claim 13, wherein the plurality of factors comprise at least one of a physical proximity of the peer node to the node, a latency between the peer node and the node, compute resource cost for a copying or a transfer of the non-compromised version of the compromised event from the peer node to the node, the peer node having previously successfully processed the non-compromised version, the non-compromised version stored without error in the peer node, the physical proximity of the peer node to the node, the latency between the peer node and the node, the number of processes currently running or in queue at the peer node, the number of calls to the peer node, a history of the peer node, the availability of the non-compromised version of the compromised event at other peer nodes.

17. A decentralized automatically synchronizing distributed system, comprising:
a plurality of data centers, connected to an event source node, wherein each data center of the plurality of data centers comprises a landing storage, a staging storage, and a peer staging storage, each data center comprising a memory storing instructions executable by a processor to:
initiate, based on a condition, a synchronization event;
query, a log queue for events processed by at least one of the plurality of data centers;
retrieve, from the log queue the events processed in at least one of the plurality of data centers;
identify, a discrepancy between the events processed by at least one of the plurality of data centers and events stored in a local event log, wherein the discrepancy indicates an event error, wherein an event error comprises either an error in an event in the local event log or a missing event from the local event log;
determine, a compromised event associated with the event error in the local event log based on the discrepancy;
retrieve, a non-compromised copy of the compromised event from a staging storage of a peer data center, wherein the peer node is selected from the plurality of peer nodes based on a plurality of factors;
store, the non-compromised copy of the compromised event of the missing event in the peer staging storage; and
transfer, all events from the peer staging storage to the landing storage.

18. The system of claim 17, wherein the condition is at least one of an external event, or an implicit invariant condition.

19. The system of claim 18, wherein the implicit invariant condition may comprise at least one of a number of events processed, a time lapsed, a time, a date, a time-lapsed since a previous synchronization event, or a frequency of synchronization events.

20. The system of claim 17, wherein the plurality of factors comprise at least one of a physical proximity of the peer node to the node, a latency between the peer node and the node, compute resource cost for a copying or a transfer of the non-compromised copy of the compromised event from the peer node to the node, the peer node having previously successfully processed the non-compromised copy, the non-compromised copy stored without error in the peer node, the physical proximity of the peer node to the node, the latency between the peer node and the node, the number of processes currently running or in queue at the peer node, the number of calls to the peer node, a history of the peer node, the availability of the non-compromised copy of the compromised event at other peer nodes.
